(19) United States
(12) Patent Application Publication
(10) Pub. No.: US 2014/0358874 A1
(43) Pub. Date: Dec. 4, 2014

(54) COMPRESSION SYSTEM AND METHOD

(71) Applicant: Avaya Inc., Basking Ridge, NJ (US)

(72) Inventor: Jon Bentley, New Providence, NJ (US)

(73) Assignee: Avaya Inc., Basking Ridge, NJ (US)

(21) Appl. No.: 13/907,319

(22) Filed: May 31, 2013

(51) Int. Cl. G06F 17/30

(52) U.S. Cl. CPC G06F 17/30153
USPC 707/693

(57) ABSTRACT

A plurality of lines of data from a file are stored in a cache. The lines of data typically come from a file that is being compressed. The process gets an additional line of data to compress. Based on a compression level, the additional line of data is compared with the lines of data in the cache to determine if there is a best matched line of data from the plurality of lines in the cache. In response to determining the best matched line of data, the additional line of data is compressed with a first compression algorithm based on the best matched line of data to create a compressed line. The compressed line is written to the file. In response to not determining the best matched line of data, the additional line of data is written to the file. The additional line of data is stored in the cache.

### TECHNICAL FIELD

The systems and methods that relate to compression algorithms and in particular to file compression algorithms.

### BACKGROUND

Today, the use of various kinds of compression is in common use. For example, compression algorithms such as gzip are used to compress files. Existing compression algorithms look for defined patterns in data for areas of the data to compress. These compression algorithms can achieve high levels of compression. However, in some areas, where the information stored contains a large number of similar lines of data, such as a log file, existing compression algorithms fall short in the level of compression that can be achieved. What is needed is a compression algorithm that overcomes the existing limitations of current compression algorithms.

### SUMMARY

Systems and methods are provided to solve these and other problems and disadvantages of the prior art. A plurality of lines of data from a file are stored in a cache. The lines of data typically come from a file that is being compressed. The process gets an additional line of data. For example, the next line of data to compress. Based on a compression level, the additional line of data is compared with the lines of data in the cache to determine if there is a best matched line of data from the plurality of lines in the cache. In response to determining the best matched line of data, the additional line of data is compressed with a first compression algorithm based on the best matched line of data to create a compressed line. The compressed line is written to the file. In response to not determining the best matched line of data, the additional line of data is written to the file. The additional line of data is stored in the cache.

### BRIEF DESCRIPTION OF THE DRAWINGS

FIG. 1 is a block diagram of a first illustrative system for compressing information in a file.

FIG. 2 is a flow diagram of a method for compressing information in a file.

FIG. 3 is a flow diagram of a method for managing information in a cache.

FIG. 4 is a flow diagram of a method for determining if there is a best matched line of data for compression.

### DETAILED DESCRIPTION

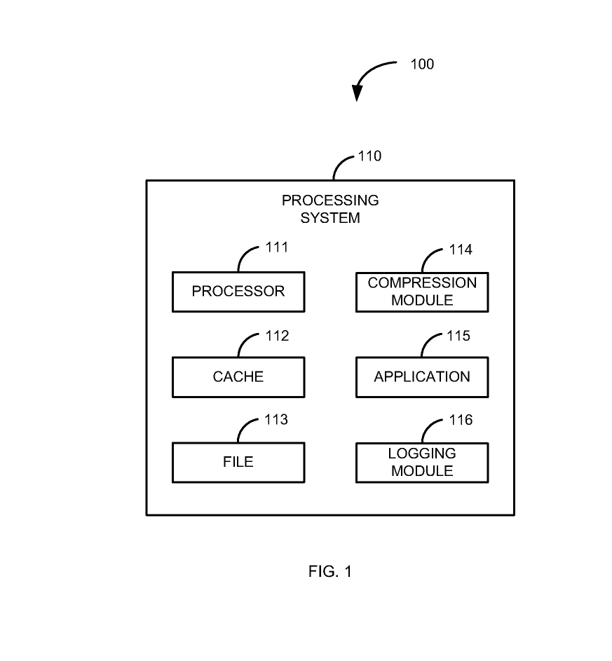

FIG. 1 is a block diagram of a first illustrative system 100 for compressing information in a file. The first illustrative system 100 comprises processing system 110. The processing system may be any device/software that can process information, such as a Personal Computer (PC), a telephone system, a video system, a Private Branch Exchange (PBX), a router, a mainframe computer, an operating system, a communication device, a server, a web server, an email system, a central office switch, a switching system, an array of computers, and/or the like.

The processing system 110 comprises a processor 111, a cache 112, a file 113, a compression module 114, an application 115, and a logging module 116. The elements of processing system 110 are all shown as components of the processing system 110. However, in some embodiments, the various elements 111-116 may be distributed across a network on multiple devices. For example, the file 113 may be stored in a database on a network. The processor 111 can be any processing device, such as a microprocessor, a Digital Signaling Processor (DSP), a micro-controller, an array of processors, a multi-core processor, and/or the like.

The cache 112 can be any type of area for storage of data, such as a Random Access Memory (RAM), a flash memory, a cache memory in a microprocessor, an array, a list, a buffer, storage on a disk, and/or the like. The cache 112 can be any defined size. For example, in an embodiment, the cache 112 can have a size of 20 lines. The size of the cache may be based on an optimized value, the compression algorithm used, the type of data being compressed, and/or the like. The size of the cache 112 can be based on lines, lines of characters, a number of characters, bytes, words, long words, bits, software objects, text objects, data objects, and/or the like. The cache 112 may include one or more caches. In one embodiment, the cache 112 is in a Random Access Memory or a cache in a microprocessor and the file 113 is stored on a hard disk.

The file 113 can be any type of storage that can store information, such as a data structure, a database, information stored in memory, and/or the like. The file 113 can comprise one or more files.

The compression module 114 can be any hardware/software that can process information for compression. The compression module 114 can use one or more compression algorithms for compressing information. For example, the compression module 114 can use zip, Gzip, PKZIP, Lempel-Ziv, Lempel-Ziv-Welch, any of the compression algorithms described herein, and/or the like.

The processing system 110 may also include the application 115 and the logging module 116. The application 115 can be any software/hardware that can process information, such as a telephony application, a networking application, a network analyzer, a router, an operating system, a computing system, and/or the like. The logging module 116 can be any software/hardware that can log information for the application 115. For example, the logging module 116 can log events that occur in a telephony or network routing application. The events that are logged by the logging module 116 may be stored in the file 113. The events that are logged by the logging module 116 may be logged in real-time and written to file 113 in real-time as the events occur. Alternatively, the events may be written to the file 113 when a process is complete, periodically in a batch mode, before an archival, and/or the like.

The compression module 114 stores lines of data from the file 113 in the cache 112. A line of data can be any type of information that is delineated. For example, a line of data can be delineated by a specific character such as a line feed, a carriage return, an end of line, an object identifier, a specific character, an array size, a null terminator, and/or the like. Alternatively, the line of data can be determined based on a specific number of characters of data, number of a specific type of characters, a type of software object, a line length, and/or the like. For example, if the file 113 contains lines of intermixed alpha numeric and non-alpha numeric characters, the compression module may only process the alpha numeric lines of data or the non-alpha numeric lines of data. The compression module 114 may store the lines (a plurality) of data from the file 113 in various ways. For example, the compression module 114 may read the first 10 lines of the file 113 and store the first 10 lines in the cache 112. Alternatively, the compression module 114 may read lines from the back of file 113. The compression module 114 may read in one line of data at a time from the file 113 to store in cache 112. The lines of data in the cache 112 may occur in the file before or after the position of the additional line of data.

The compression module 114 gets an additional line of data. The additional line of data can come from reading a line from the file 113, can be received in real-time from logging module 116 when the line of data is generated by the logging module 116, can be received from a communication device in a network (e.g., from a network analyzer or router), can be received from the application 115, can be stored on a disk, and/or the like. The compression module 114 compares the additional line of data with the stored lines of data in the cache 112 to determine, based on a level of compression, if there is a best matched line of data from the lines of data in the cache 112. A level of compression can be any level of compression. For example, a user or administrator may define a compression level of 70%. The compression level may be stored in a profile. The compression level is typically based on the amount of compression of an individual line. However, in other embodiments, other factors may be used to define a level of compression. For example, the compression level may be based on the best matched line of data and/or the overall compression of the file 113.

In response to determining the best matched line of data, the compression module 114 compresses the additional line of data with a compression algorithm based on the best matched line of data to create a compressed line. The compressed line is written to the file 113. In response to not determining a best matched line of data, the compression module 114 writes the additional line to the file 113. The compression module 114 stores the additional line of data in the cache 112.

To further illustrate, consider the following example. The file 113 contains the following two lines that have been stored in the cache 112.

| File 113 | Cache 112 |
|---|---|
| aaaaaaaaaaaaaaaaaaaa | aaaaaaaaaaaaaaaaaaaa |
| ccccccccccccccccccccc | ccccccccccccccccccccc |

The line with 20 a's is the first line in the file 113 and the line with 20 c's is the second line in the file 113. The compression module 114 gets an additional line of data that is generated by the logging module 116. The additional line of data contains “bbbbbbbbbbbbbbbbbbbb” (20 b's). The compression module 114 compares the additional line of data with the 20 b's to the lines of data in the cache (the lines with a's and b's) to determine based on a level of compression (e.g., 70%), if there is a best matched line of data from the lines of data in the cache 112. In this example, since each the lines of data are completely different, a best matched line of data is not determined because no compression can be accomplished based on the two lines of data in the cache 112 using the compression alogirtym. The compression module 114 writes the additional line of data “bbbbbbbbbbbbbbbbbbbbb” to the file 113 and the cache 112. The updated file 113 and the updated cache 112 are shown below.

| File 113 | Cache 112 |
|---|---|
| aaaaaaaaaaaaaaaaaaaa | aaaaaaaaaaaaaaaaaaaa |
| ccccccccccccccccccccc | ccccccccccccccccccccc |
| bbbbbbbbbbbbbbbbbb | bbbbbbbbbbbbbbbbbb |

The compression module 114 gets a second additional line of data generated by logging module 116. The second additional line of data contains “aaaaaaaaaaaaaaaaaaaa” (20 a's). The second additional line of data is compared with the lines of data in the cache 112 to determine, based on the compression level, if there is a best matched line of data the cache 112. In this example, the first line in the cache is identical to the second additional line of data and is the best matched line of data. In response to determining the best matched line of data (line 1 in the cache 112), the compression module 114 compresses the second additional line of data based on the best matched line of data (line 1 in the cache) to create a compressed line. The compressed line is written to the file 113 and the second additional line is written to the cache 112. The updated file 113 and the updated cache 114 are shown below:

| File | Cache 112 |
|---|---|
| aaaaaaaaaaaaaaaaaaaa | aaaaaaaaaaaaaaaaaaaa |
| ccccccccccccccccccccc | ccccccccccccccccccccc |
| bbbbbbbbbbbbbbbbbb | bbbbbbbbbbbbbbbbbb |
| 1*20 | aaaaaaaaaaaaaaaaaaaa |
| | (after written to cache) |

In this example, the 4^{th} line in the file 113 was compressed by 80% (from 20 characters to 4 characters). The 80% compression is greater than the 70% compression; therefore a best match is made. In this example, the compression algorithm compares the characters in the file until there is not a match. The cache 112 in essence represents what the key lines from the file 113 would look like if the file 113 was not compressed.

In an alternative embodiment, instead of compressing the 4^{th} line to 1*20, because the whole line was compressed, a 1 could be written in line 4. This indicates that the whole line was compressed. This would give a 95% compression level.

In another embodiment, the 4^{th} line in the cache 112 may not be written to the cache 112 because the 4^{th} line in the cache 112 is the same as the 4^{th} line in the cache 112. This limits the number of lines in the cache 112 where there are duplicate lines.

The line number is used to by a decompression algorithm to identify the line that was used to compress a compressed line. To illustrate, consider the previous example from FIG. 1 as shown below.

File 113

aaaaaaaaaaaaaaaaaaaa
ccccccccccccccccccccc
bbbbbbbbbbbbbbbbbb
1*20

In this example, line 4 was identical to line 1 before line 4 was compressed. The 1*20 in line 4 of the file indicates that line 1 was used to compress the all 20 characters of line 4. The decompression algorithm uses the 1 to identify the first line and the 20 to determine the number of characters of the first line that were used to compressed (in this example all 20 characters) line 4. To decompress the file, the decompression algorithm copies the 20 characters from line 1 into line 4. In this example, all the characters of the line are compressed. However, for other inputs, only a portion of the characters in a line may match. For example, only the first 10 characters of line 1 would match if line 1 was “aaaaaaaaaaxxxxxxxxxx” (i.e., the compressed line would be “1*10xxxxxxxxxx”).

The above described examples are just one of many types of compression algorithms that may be used. In addition, the compression algorithm described above can be used in with other compression algorithms, such a gzip to provide further compression of the file 113.

The compression algorithm can be used to compress different types of information in a file. For example, the compression algorithm can be used for comparing software objects that are stored in an I/O stream in order to further compress the file 113 that contains the software objects.

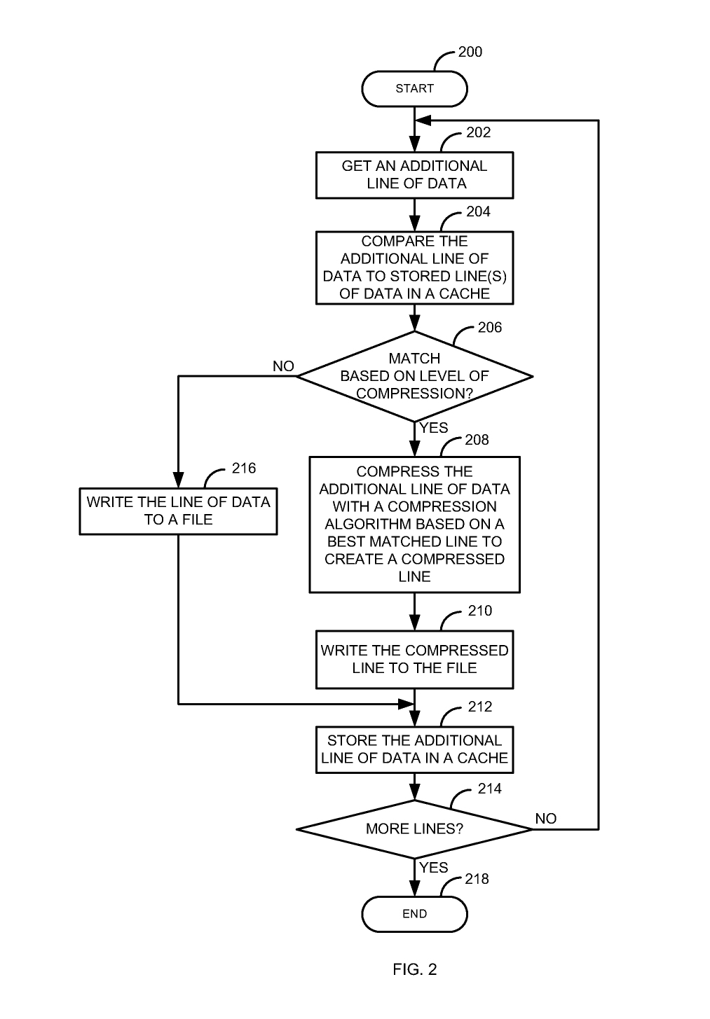

FIG. 2 is a flow diagram of a method for compressing information in a file. Illustratively, the processing system 110, the compression module 114, the application 115, and the logging module 116 are stored-program-controlled entities, such as a computer or processor 111, which performs the method of FIGS. 2-4 and the processes described herein by executing program instructions stored in a tangible computer readable storage medium, such as a memory or disk. Although the methods described in FIGS. 2-4 are shown in a specific order, one of skill in the art would recognize that the steps in FIGS. 2-4 may be implemented in different orders and/or be implemented in a multi-threaded environment. Moreover, various steps may be omitted or added based on implementation.

The process starts in step 200. The process gets 202 an additional line of data. The additional line of data is compared 204 to stored lines of data in the cache. The process determines in step 206, based on a compression level, if there is a best matched line of data from the lines of data in the cache. If there is not a best matched line of data based on the level of compression in step 206, the process writes 216 the additional line of data to the file and goes to step 212.

Otherwise, if the process determines that there is a best matched line of data based on a level of compression in step 206, the process compresses 208 the additional line of data with a compression algorithm based on the best matched line of data to create a compressed line. The compressed line is written 210 to the file. The process stores 212 the additional line of data line of data in the cache. The process determines in step 214 if there are more lines of data to compress. If there are more lines of data to compress in step 214, the process goes to step 202. Otherwise, if there are not more lines of data to compress, the process ends 218.

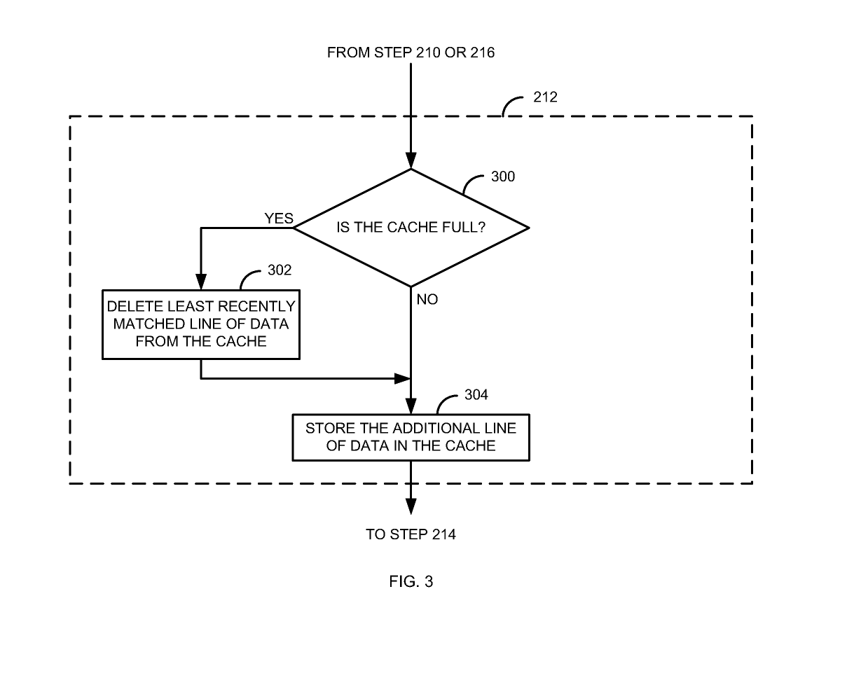

FIG. 3 is a flow diagram of a method for managing information in a cache. The process in FIG. 3 an embodiment of step 212 in FIG. 2. After completing step 210 or step 216, the process determines if the cache is full in step 300. The cache can be full based on a defined number of lines, characters, items, objects, software objects, elements, and/or the like. For example, the cache may be full based on a default value of ten software objects. If the cache is full in step 300 the process deletes 302 the last recently matched line of data from the cache and goes to step 304. If the cache is not full in step 300, the process stores 304 the additional line of data in the cache. The process goes to step 214.

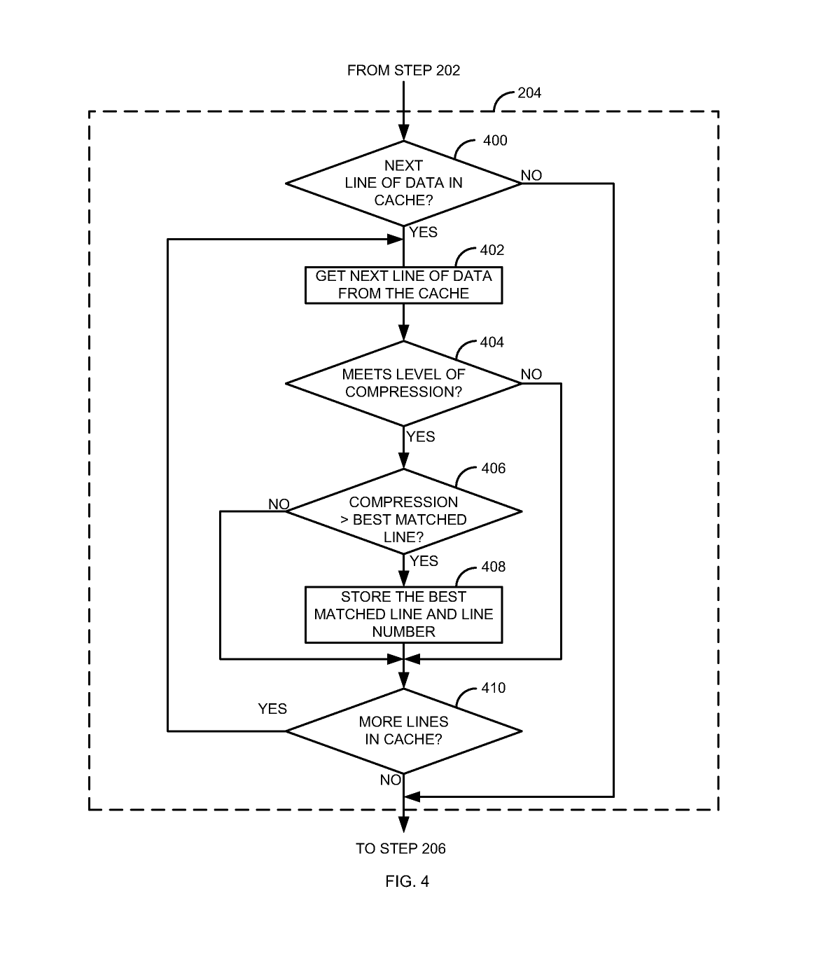

FIG. 4 is a flow diagram of a method for determining if there is a best matched line of data for compression. The process described in FIG. 4 is an exemplary embodiment of step 204 of FIG. 2. After getting the additional line of data in step 202, the process determines in step 400 if there is a next line of data in the cache. If there is not a next line of data in the cache in step 400, the process goes to step 206. There may not be a next line of data in the cache in step 400 because the process has processed each line in the file. Alternatively, this could be the first time that a line is compared when a file is empty.

If the process determines in step 400 that there is a next line of data in the cache, the process gets 402 the next line of data from the cache. The process determines in step 404 if a comparison between the next line of data in the cache and the additional line of data (from step 202) meets a level of compression. If the comparison between the next line of data in the cache and the additional line of data does not meet a level of compression in step 404, the process goes to step 410.

Otherwise, if the process determines in step 404 that the comparison meets the level of compression, the process determines in step 406 if the compression is greater than the current best matched line of data. If the process determines in step 406 that the compression is not greater than the current best matched line of data, the process goes to step 410. Otherwise, if the process determines in step 406 that the level of compression is greater than the current best matched line of the data, the process stores 408 a new best matched line of data and line number. The process determines in step 410 if there are more lines of data in the cache. If there are more lines of data in the cache, the process goes to step 402. Otherwise, the process goes to step 206.

The best matched line of data is used to compress the additional line of data in step 208. In one embodiment, the best matched line of data is compared to the additional line of data to compare a repetition of characters between the two lines. For example, if the first line of the file that is stored in the cache contained the string “abcdefghijklmnop” and the additional line of data (that is line 4 of the file) contained the string abcdefghijklxxxx, the system would determine a repetition of the characters abcdefghijkl that is common between the two lines. The system will compress the additional line to 4*12xxxx and write the compressed line to the 4^{th} line in the file (either overwriting the existing fourth line if the process compresses an existing file or adds the fourth line if the lines are being added in real time).

In the above embodiment, the process determines the repetition of characters from the start of the line. However, in other embodiments, the process can start from any point in the line of data where there are multiple character similarities. For example, if the additional line of data is “xxabcdefghijklmnopxx” and the line of data from the cache is “AXabcdefghijklmnopHELLO” the compression algorithm can compress the additional line of data to xx1*15xx.

In another embodiment, the process can identify a plurality of repetitions of characters in a line. For example, consider the example shown below.

| File | Cache |
|---|---|
| aaaaaaaaaaCCbbbbbbbbbb | aaaaaaaaaaCCbbbbbbbbbb |
| 1*10, CC, 1*10 | aaaaaaaaaaDDbbbbbbbbbb |
| | (after written to cache) |

In this example, the second line in the file is compressed by comparing the line repetitions “aaaaaaaaaa” and “bbbbbbbbbb.” The resulting compression line that is written to the file shows the 1*10 indicating that the first 10 characters come from the first ten characters of line 1. The CC is the non matching characters from line 2 and the second 1*10 indicates characters 13-22 are taken correspondingly from characters 13-22 of line 1. The commas are for illustrative purposes and may or may not be used based on implementation.

In another embodiment, the process compares a plurality of repetitions from a second best matched line of data. For example, consider the example shown below.

| File | Cache |
|---|---|
| abcdefghijklmnopqrstuv | abcdefghijklmnopqrstuv |
| bbbbbbbbbbbbbbbbbbb | bbbbbbbbbbbbbbbbbbb |
| 1*10, 2*10 | abcdefghijbbbbbbbbbb |
| | (after written to cache) |

The process determines two best matched lines of data lines 1 and 2 of the file lines stored in the cache. Based on the repetitions of characters in characters 1-10 of line 1 and characters 1-10 of line 2, the process compresses line 3 to 1*10, 2*10. The process could use lines 11-20 of the second line by compressing line 3 to for example, 1*10, 2#11*10. The 2#11 indicates to start taking characters from the 11^{th} character and the *10 indicates to take 10 characters.

The above examples use characters such as numbers, *'s, #′, and the like to illustrate how the process can be implemented. However, in other embodiments, non-alpha numeric characters may be used do to the fact that the above characters are likely to arise in standard text strings. Alternatively, the process could determine a compressed line based on a specific character(s), character sequences, or number of characters to distinguish a compressed line or portion of a line from a non-compressed line.

Of course, various changes and modifications to the illustrative embodiment described above will be apparent to those skilled in the art. These changes and modifications can be made without departing from the spirit and the scope of the system and method and without diminishing its attendant advantages. The following claims specify the scope of the invention. Those skilled in the art will appreciate that the features described above can be combined in various ways to form multiple variations of the invention. As a result, the invention is not limited to the specific embodiments described above, but only by the following claims and their equivalents.

What is claimed is:

1. A method for compressing data, comprising:
storing a plurality of lines of data from a file in a cache;
getting an additional line of data;
comparing the additional line of data with the stored plurality of lines of data in the cache to determine, based on a level of compression, if there is a best matched line of data from the plurality of lines of data in the cache;
in response determining the best matched line of data, compressing the additional line of data with a first compression algorithm based on the best matched line of data to create a compressed line and writing the compressed line to the file;
in response to not determining the best matched line of data, writing the additional line of data to the file; and
storing the additional line of data in the cache.

2. The method of claim 1, further comprising:
determining if the cache is full; and
in response to the cache being full, deleting a least recently matched line of data from the cache.

3. The method of claim 1, wherein the file is a log file stored on a hard disk and the cache is a Random Access Memory (RAM) or a cache in a microprocessor.

4. The method of claim 1, wherein the first compression algorithm comprises:
comparing a repetition of characters in the additional line of data to the best matched line of data to identify a number of matched characters; and
replacing the number of matched characters with an identifier representing the number of matched characters and a line number of the best matched line of data in the file.

5. The method of claim 4, wherein a plurality of repetitions of characters in the additional line of data are compared to the best matched line of data.

6. The method of claim 5, wherein the plurality of repetitions of characters in the additional line of data are compared to the best matched line of data and a second best matched line of data.

7. The method of claim 6, wherein the compressed line further comprises a line number of the second best matched line of data in the file.

8. The method of claim 1, further comprising applying a second compression algorithm to the compressed line before writing the compressed line to the file.

9. The method of claim 1, wherein at least one of the stored plurality of lines is a line of data in the file that is after the additional line of data.

10. The method of claim 1, wherein the additional line of data is processed in real-time when the additional line of data is generated by a logging module.

11. The method of claim 1, wherein the first compression algorithm compares software objects in an Input/Output (I/O) stream.

12. A system for compressing data, comprising:
a cache configured to store a plurality of lines of data from a file; and
a compression module configured to get an additional line of data, compare the additional line of data with the stored plurality of lines of data in the cache to determine, based on a level of compression, if there is a best matched line of data from the plurality of lines of data in the cache, compress the additional line of data with a first compression algorithm based on the best matched line of data to create a compressed line and writing the compressed additional line of data to the file in response determining the best matched line of data, write the additional line of data to the file in response to not determining the best matched line of data, and store the additional line of data in the cache.

13. The system of claim 12, wherein the compression module is further configured to determine if the cache is full and delete a least recently matched line of data from the cache in response to the cache being full.

14. The system of claim 12, wherein the file is a log file stored on a hard disk and the cache is a Random Access Memory (RAM) or a cache in a microprocessor.

15. The system of claim 12, wherein the compression module is further configured to implement a compression algorithm that compares a repetition of characters in the additional line of data to the best matched line of data to identify a number of matched characters and replaces the number of matched characters with an identifier representing the number of matched characters and a line number of the best matched line of data in the file.

16. The system of claim 15, wherein the compression module compares a plurality of repetitions of characters in the additional line of data to the best matched line of data.

17. The system of claim 16, wherein compression module compares the plurality of repetitions of characters in the additional line of data to the best matched line of data and a second best matched line of data.

18. The system of claim 17, wherein the compressed line further comprises a line number of the second best matched line of data in the file.

19. The system of claim 12, wherein the additional line of data is processed in real-time when the additional line of data is generated by a logging module.

20. A non-transient computer readable medium having stored thereon instructions that cause a processor to execute a method, the method comprising:
instructions to store a plurality of lines of data from a file in a cache;
instructions to get an additional line of data;
instructions to compare the additional line of data with the stored plurality of lines of data in the cache to determine, based on a level of compression, if there is a best matched line of data from the plurality of lines of data in the cache;
in response to determining the best matched line of data, instructions to compress the additional line of data with a first compression algorithm based on the best matched line of data to create a compressed line and instructions to write the compressed line to the file;
in response to not determining the best matched line of data, instructions to write the additional line of data to the file; and
instructions to store the additional line of data in the cache.
